(19) United States
(12) Patent Application Publication
(10) Pub. No.: US 2003/0136622 A1
(43) Pub. Date: Jul. 24, 2003

(54) Method of supplying suspension struts

(76) Inventors: Joshua D. Coombs, Whitmore Lake, MI (US); Jeremy R. Edmondson, Canton, MI (US)

Correspondence Address: BRINKS HOFER GILSON & LIONE, P.O. BOX 10395, CHICAGO, IL, 60611, US

(21) Appl. No.: 10/203,153

(22) PCT Filed: Dec. 7, 2001
(86) PCT No.: PCT/US01/47683

(51) Int. Cl. F16F 9/00

(52) U.S. Cl. 188/315; 188/322.19

(57) ABSTRACT

An efficient method of supplying a first series of suspension struts for a first vehicle and a second series of suspension struts for a second vehicle. The method includes providing a first series of pressure vessels for the first vehicle and a second series of pressure vessels for the second vehicle. Each pressure vessel defines an outer cavity with an effective fluid volume. The effective fluid volume of the pressure vessels of the first series is smaller than the effective fluid volume of the pressure vessels of the second series. The method also includes providing a series of hydraulic tubes for the first vehicle and for the second vehicle, wherein each hydraulic tube is adapted to be located within the outer cavity of the pressure vessel of the first series and alternatively within the outer cavity of the pressure vessel of the second series.

### CROSS-REFERENCE TO RELATED APPLICATIONS

The present invention claims priority to U.S. Provisional Application Serial No. 60/251,951, filed Dec. 7, 2000, entitled “Compressible Fluid Strut”.

### TECHNICAL FIELD

The subject matter of this invention generally relates to suspension struts for a vehicle and, more particularly, to an efficient method of supplying a first series of suspension struts for a first vehicle and a second series of suspension struts for a second vehicle.

### BACKGROUND

In the typical vehicle, a combination of a coil spring and a gas strut function to allow compression movement of a wheel toward the vehicle and rebound movement of the wheel toward the ground. The combination attempts to provide isolation of the vehicle from the roughness of the road and resistance to the roll of the vehicle during a turn. More specifically, the typical coil spring provides a suspending spring force that biases the wheel toward the ground and the typical gas strut provides a damping force that dampens both the suspending spring force and any impact force imparted by the road. Inherent in every conventional suspension strut, however, is a compromise between ride (the ability to isolate the vehicle from the road surface) and handling (the ability to resist roll of the vehicle).

Because of the inherent compromise, automotive manufacturers typically provide unique suspension struts on their vehicles, including vehicles based on the same platform and built in the same factory, which leads to cost-inefficiencies. For this reason, there is a need in the art of suspension struts to create a more efficient method of supplying suspension struts to a first vehicle and second vehicle.

### BRIEF DESCRIPTION OF THE DRAWINGS

FIG. 1 is a front view of a suspension strut installed in a vehicle.

FIG. 2 is a schematic view of the first series of pressure vessels, the series of hydraulic tubes, and the second series of pressure vessels, as provided by the first preferred method.

FIG. 3A is a cross-sectional view of a suspension strut of a first series, as provided by a first preferred method.

FIG. 3B is a cross-sectional view of a suspension strut of a second series, as provided by the first preferred method.

FIG. 4 is a cross-sectional view of an alternative suspension strut of the first series, as provided by a second preferred method.

### DETAILED DESCRIPTION OF THE PREFERRED METHODS

The following description of the preferred methods of the invention are not intended to limit the invention to these preferred methods, but rather to enable any person skilled in the art of suspension struts to use this invention.

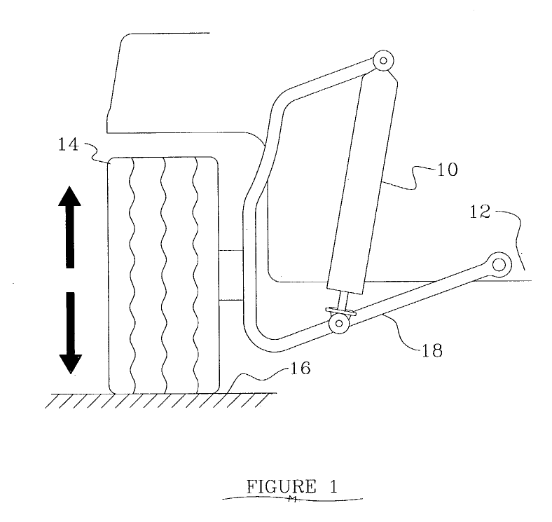

As shown in FIG. 1, the suspension struts 10 provided by the preferred methods have been specifically designed for vehicles 12 having a wheel 14 contacting a surface 16 under the vehicle 12 and a suspension link 18 suspending the wheel 14 from the vehicle 12. The suspension link 18 allows compression movement of the wheel 14 toward the vehicle 12 and a rebound movement of the wheel 14 toward the surface 16. Despite its design for this particular environment, however, the suspension strut 10 may be used in any suitable environment.

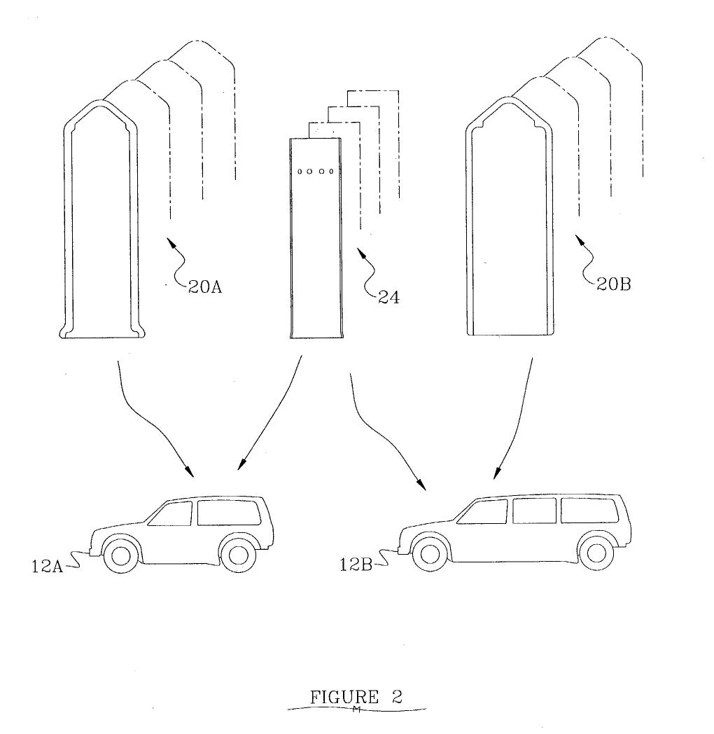

As shown in FIG. 2, the first preferred method includes providing a first series of pressure vessels 20A for a first vehicle 12A, providing a second series of pressure vessels 20B for a second vehicle 12B, and providing a series of hydraulic tubes 24 for the first vehicle 12A and for the second vehicle 12B. Each of the hydraulic tubes 24 are adapted to be located within the pressure vessel 20A of the first series and alternatively within the pressure vessel 20B of the second series. In this manner, the suspension struts may be efficiently supplied for a first vehicle 12A and for a second vehicle 12B. The first preferred method of the invention may, of course, include providing other suitable components for the suspension struts, including the components discussed below and any components envisioned by a skilled person in the art of suspension struts.

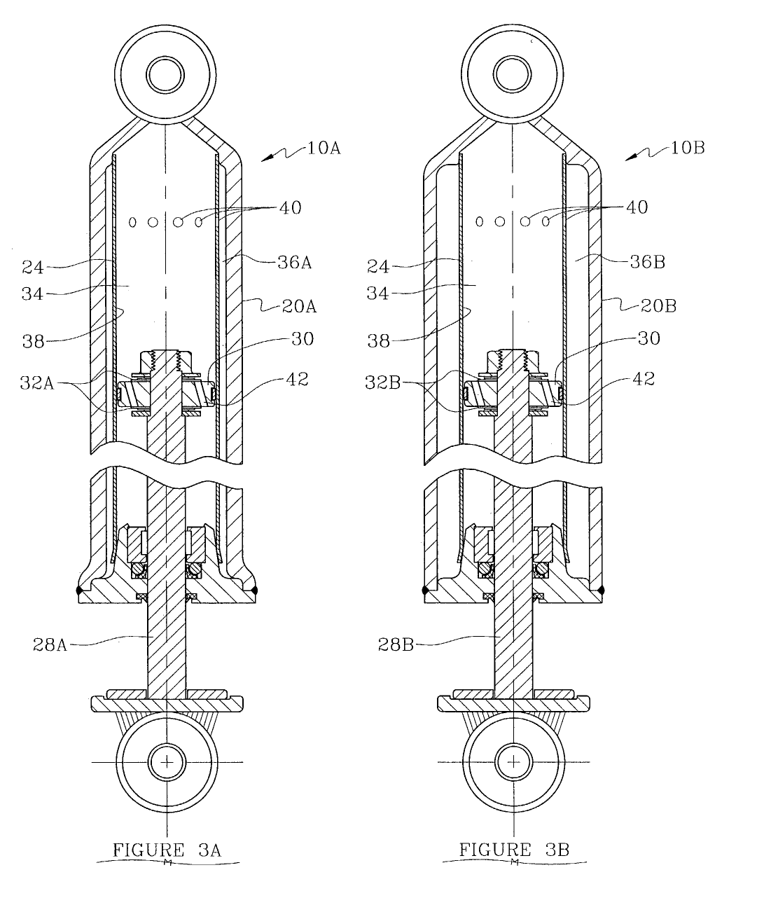

As shown in FIGS. 3A and 3B, the suspension struts 10A and 10B provided by the first preferred method also include a first series of displacement rods 28A for the first vehicle, a second series of displacement rods 28B for the second vehicle, a series of cavity pistons 30 for the first vehicle and for the second vehicle, a first series of variable restrictors 32A for the first vehicle, a second series of variable restrictors 32B for the second vehicle, and compressible fluid 34. The pressure vessel 20, the hydraulic tube 24, the displacement rod 28, and the compressible fluid 34 cooperate to supply a suspending spring force that biases the wheel 32 toward the surface, while the cavity piston 30 and the variable restrictor cooperate 32 to supply a rebound damping force that dampens the suspending spring force.

The pressure vessel 20 and the hydraulic tube 24 provided by the preferred method cooperate to define an outer cavity 36 located between the hydraulic tube 24 and the pressure vessel 20, which functions to contain a portion of the compressible fluid 34. The hydraulic tube 24 defines an inner cavity 38, which functions to contain another portion of the compressible fluid 34. The hydraulic tube 24 defines a tube opening 40, which functions to fluidly connect a portion of the inner cavity 38 and the outer cavity 36. Each outer cavity 36 has an effective fluid volume. The effective fluid volume of the pressure vessels 20A of the first series is smaller than the effective fluid volume of the pressure vessels 20B of the second series, as further discussed below. The pressure vessels 20 and the hydraulic tubes 24 are preferably made from conventional materials and with conventional methods, but may alternatively be made from any suitable material and with any suitable method.

The displacement rods 28 provided by the first preferred method are adapted to move into the inner cavity 38 upon compression movement of the wheel and to move out of the inner cavity 38 upon the rebound movement of the wheel. As it moves into the inner cavity 38, the displacement rod 28 displaces, and thereby compresses, the compressible fluid 34. In this manner, the movement of the displacement rod 28 into the inner cavity 38 increases the suspending spring force of the suspension strut 10. As the displacement rod 28 moves out of the inner cavity 38, the compressible fluid 34 decompresses and the suspending spring force of the suspension strut 10 decreases. Each of the displacement rods 28 defines a cross-sectional area. In the first preferred method, the cross-sectional area of the displacement rods 28A of the first series is smaller than the cross-sectional area of the displacement rods 28B of the second series, as will be further discussed below. The displacement rods 28 are preferably made from conventional steel and with conventional methods, but may alternatively be made from any suitable material and with any suitable method.

The cavity pistons 30 provided by the first preferred method are coupled to the displacement rods 28 and extend to the hydraulic tubes 24. In this manner, the cavity pistons 30 separate the inner cavity 38 into a first section and a second section. Each cavity piston 30 is adapted to be coupled with the displacement rods 28A of the first series and alternatively with the displacement rods 28B of the second series. Each cavity piston 30 defines an orifice 42, which allows flow of the compressible fluid 34 between the first section and the second section of the inner cavity 38. The cavity pistons 30 are preferably made from conventional materials and with conventional methods, but may alternatively be made from other suitable materials and with other suitable methods.

The variable restrictors 32 provided by the first preferred method are coupled to the cavity piston 30 near the orifice 42. The variable restrictors 32 function to restrict the passage of the compressible fluid 34 through the orifice 42 and, more importantly, function to variably restrict a passage based on the velocity of the cavity piston 30 relative to the hydraulic tube 24. The variable restrictors 32 are preferably a shim stack made from conventional materials and with conventional methods, but may alternatively include other suitable devices able to variably restrict the passage of the compressible fluid 34 through the orifice 42 based on the velocity of the cavity piston 30 relative to the hydraulic tube 24.

The compressible fluid 34 provided by the first preferred method, which cooperates to supply the suspending spring force, is preferably a silicone fluid that compresses about 1.5% volume at 2000 psi, about 3% volume at 5000 psi, and about 6% volume at 10,000 psi. Above 2000 psi, the compressible fluid 34 has a larger compressibility than the conventional hydraulic oil. The compressible fluid 34, however, may alternatively be any suitable fluid, with or without a silicone component, that preferably provides a larger compressibility above 2000 psi than conventional hydraulic oil.

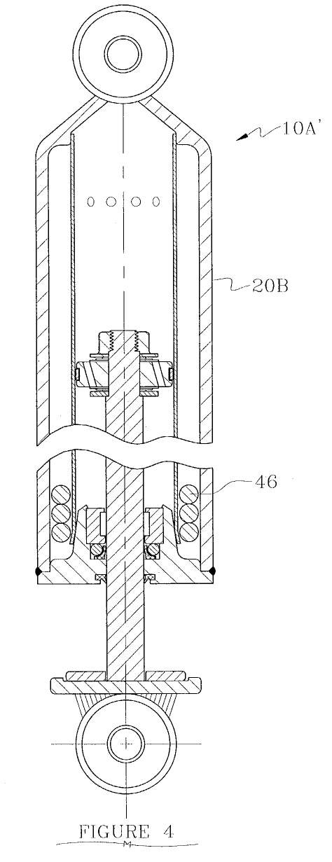

As shown in FIG. 4, the suspension struts 10A′ provided by the second preferred method of the invention include the pressure vessels 20B of the second series and a volume reducer 46. The volume reducer 46 functions to reduce the effective fluid volume of the pressure vessels 20B such that the effective fluid volume for the first vehicle is smaller than the effective fluid volume for the second vehicle. In this manner, the second preferred method realizes further improved efficiencies by using the same pressure vessel 20B in the suspension struts 10A′ and 10B of the first vehicle and the second vehicle.

The preferred methods of the invention were created for supplying suspension struts 10 to a first vehicle that is lighter than a second vehicle. More specifically, the preferred methods were created for supplying suspension struts 10 to first vehicles and second vehicles based on the same platform and built in the same factory, such as a Ford Explorer two-door vehicle and a Ford Explorer four-door vehicle. In this situation, the automotive manufacturer realizes significant cost efficiency if the same supplier supplies both the suspension struts 10 for the first vehicle and the second vehicle. Because the weight of the second vehicle is different than the weight of the first vehicle, the suspension struts 10 for the two vehicles must be designed differently. The preferred methods of the invention minimize the design differences of the suspension struts 10 by using several common components. Preferably, only the displacement rods 28, the pressure vessels 20, and the variable restrictors 32 are not common between the suspension struts 10 of the first vehicle and the second vehicle.

The design of the displacement rods 28 is based on a predetermined static pressure of the inner cavity 38 and on the vehicle weight. By understanding that pressure=force/area, as the weight of the vehicle 12 increases the area of the displacement rod 28 must also increase to establish a predetermined static pressure in the inner cavity 38 of the suspension struts 10. Thus, the preferred methods of the invention include choosing the cross-sectional area of the displacement rods 28A and 28B of the first series and the second series such that a pressure within the inner cavity 38 of the suspension strut 10A installed on the first vehicle 12A is substantially similar to a pressure within the inner cavity 38 of the suspension strut 10B installed on the second vehicle 12B.

As discussed above, the suspending spring force changes as the displacement rod 28 enters the inner cavity 38. This change, otherwise known as the spring rate of the suspension strut 10, is based on the change of volume of compressible fluid 34 for a given stroke of the displacement rod 28 within the inner cavity 38 of the suspension strut 10. Since the displacement rod 28B of the second series has a larger cross-sectional area, it displaces more compressible fluid 34 than the displacement rod 28A of the first series for a given stroke length. For this reason, the effective fluid volume of the pressure vessel 20B of the second series must be larger than the effective fluid volume of the pressure vessel 20A of the first series to provide a similar or exact change in volume of the compressible fluid 34 for a given stroke of the displacement rod 28. Thus, the preferred methods of the invention include choosing the effective fluid volume of the pressure vessels 20A and 20B of the first series and the second series such that the spring rate for the suspension struts 10A installed in the first vehicle is substantially similar to the spring rate for the suspension struts 10B installed in the second vehicle.

As any person skilled in the art of suspension struts will recognize from the previous detailed description and from the figures and claims, modifications and changes can be made to the two preferred methods of the invention without departing from the scope of this invention defined in the following claims.

We claim:

1. A method of supplying a first series of suspension struts for a first vehicle, and a second series of suspension struts for a second vehicle, wherein each vehicle includes a wheel and a suspension link adapted to suspend the wheel from the vehicle and to allow relative movement of the wheel and the vehicle, said method comprising:
providing a first series of pressure vessels for the first vehicle, and a second series of pressure vessels for the second vehicle, wherein each pressure vessel defines an outer cavity with an effective fluid volume, and wherein the effective fluid volume of the pressure vessels of the first series is smaller than the effective fluid volume of the pressure vessels of the second series; and
providing a series of hydraulic tubes for the first vehicle and for the second vehicle, wherein each hydraulic tube is adapted to be located within the outer cavity of the pressure vessel of the first series and alternatively within the outer cavity of the pressure vessel of the second series.

2. The method of claim 1 wherein each hydraulic tube defines an inner cavity and a tube opening to fluidly connect the inner cavity and the outer cavity.

3. The method of claim 2 further comprising providing a first series of displacement rods for the first vehicle, and a second series of displacement rods for the second vehicle, wherein each displacement rod is adapted to move into and out of the inner cavity of the hydraulic tubes upon the relative movement of the wheel and the vehicle, wherein each displacement rod defines a cross-sectional area, and wherein the cross-sectional area of the displacement rods of the first series is smaller than the cross-sectional area of the displacement rods the second series.

4. The method of claim 3 further comprising providing a series of cavity pistons for the first vehicle and for the second vehicle, wherein each cavity piston is adapted to be coupled with the displacement rods of the first series and alternatively with the displacement rods of the second series; and wherein each cavity piston is adapted to supply a damping force during the relative movement of the wheel and the vehicle.

5. The method of claim 4 further comprising providing a first series of variable restrictors for the first vehicle, and a second series of variable restrictors for the second vehicle, wherein each variable restrictor is adapted to be coupled with the hydraulic piston, and wherein each variable restrictor is adapted to selectively restrict passage of a fluid through an orifice in the hydraulic piston.

6. The method of claim 2 further comprising providing a compressible fluid among the inner cavity and the outer cavity of the pressure vessel of the first series, and providing a compressible fluid among the inner cavity and the outer cavity of the pressure vessel of the second series.

7. The method of claim 1 wherein providing the first series of pressure vessels includes providing the second series, of pressure vessels with a volume reducer such that the effective fluid volume of the pressure vessels for the first vehicle is smaller than the effective fluid volume of the pressure vessels for the second vehicle.

8. The method of claim 1 wherein the first vehicle is lighter than the second vehicle.

9. The method of claim 8 further comprising choosing the cross-sectional area of the displacement rods of the first series and the second series such that a pressure within the inner cavity of the suspension strut installed on the first vehicle is substantially similar to a pressure within the inner cavity of the suspension strut installed on the second vehicle.

10. The method of claim 9 further comprising choosing the effective fluid volume of the pressure vessels of the first series and the second series such that a spring rate of the suspension strut installed on the first vehicle is substantially similar to a spring rate of the suspension strut installed on the second vehicle.

11. A supply system including a first series of suspension struts for a first vehicle and a second series of suspension struts for a second vehicle, wherein each vehicle includes a wheel and a suspension link adapted to suspend the wheel from the vehicle and to allow relative movement of the wheel and the vehicle, said supply system comprising:
a first series of pressure vessels for the first vehicle, and a second series of pressure vessels for the second vehicle, wherein each pressure vessel defines an outer cavity with an effective fluid volume, and wherein the effective fluid volume of the pressure vessels of the first series is smaller than the effective fluid volume of the pressure vessels of the second series; and
a series of hydraulic tubes for the first vehicle and for the second vehicle, wherein each hydraulic tube is adapted to be located within the outer cavity of the pressure vessel of the first series and alternatively within the outer cavity of the pressure vessel of the second series.

12. The supply system of claim 11 wherein each hydraulic tube defines an inner cavity and a tube opening to fluidly connect the inner cavity and the outer cavity.

13. The supply system of claim 12 further comprising a first series of displacement rods for the first vehicle, and a second series of displacement rods for the second vehicle, wherein each displacement rod is adapted to move into and out of the inner cavity of the hydraulic tubes upon the relative movement of the wheel and the vehicle, wherein each displacement rod defines a cross-sectional area, and wherein the cross-sectional area of the displacement rods of the first series is smaller than the cross-sectional area of the displacement rods the second series.

14. The supply system of claim 13 further comprising a series of cavity pistons for the first vehicle and for the second vehicle, wherein each cavity piston is adapted to be coupled with the displacement rods of the first series and alternatively with the displacement rods of the second series; and wherein each cavity piston is adapted to supply a damping force during the relative movement of the wheel and the vehicle.

15. The supply system of claim 14 further comprising providing a first series of variable restrictors for the first vehicle, and a second series of variable restrictors for the second vehicle, wherein each variable restrictor is adapted to be coupled with the hydraulic piston, and wherein each variable restrictor is adapted to selectively restrict passage of a fluid through an orifice in the hydraulic piston.

16. The supply system of claim 12 further comprising a compressible fluid within the inner cavity and the outer cavity of the pressure vessel of the first series, and a compressible fluid within the inner cavity and the outer cavity of the pressure vessel of the second series.

17. The supply system of claim 11 wherein the first series of pressure vessels includes the second series of pressure vessels and a volume reducer such that the effective fluid volume of the pressure vessels for the first vehicle is smaller than the effective fluid volume of the pressure vessels for the second vehicle.
